(19) United States
(12) Patent Application Publication
(10) Pub. No.: US 2024/0236501 A1
(43) Pub. Date: Jul. 11, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: TOSHIYUKI FUKUI, Kanagawa (JP); AIHIKO NUMATA, Tokyo (JP)

(21) Appl. No.: 18/403,116

(22) Filed: Jan. 3, 2024

(30) Foreign Application Priority Data
Jan. 5, 2023 (JP) 2023-000710

(51) Int. Cl. H04N 23/741; H04N 23/71; H04N 23/72; H04N 23/73; H04N 23/76

(52) U.S. Cl. CPC H04N 23/741; H04N 23/71; H04N 23/72; H04N 23/73; H04N 23/76; H04N 25/618

(57) ABSTRACT

An image processing apparatus that corrects image data captured with an image sensor capable of setting for each of regions at least one exposure condition including at least one of a gain value per pixel and an exposure time includes an acquisition unit configured to acquire a dark current component in a light shielding region of the image sensor for each of the at least one exposure condition changed at predetermined intervals, and a correction unit configured to correct the image data using the dark current component acquired by the acquisition unit.

### BACKGROUND

### Field of the Disclosure

The present disclosure relates to an image processing apparatus and an image processing method that correct image data captured by an image sensor in which an exposure condition is configurable for each region, and a storage medium.

### Description of the Related Art

An image sensor is being energized even while not receiving light, and the current that flows in this state is referred to as dark current. A pixel value read from an image sensor in this state is at a certain level. In the normal pixel reading, the read pixel value partially includes a component caused by the dark current, and thus the pixel value component caused by the dark current is also referred to as a dark current component.

A dark current component typically increases the pixel values across an image. If the dark current component is not removed, the entire image appears to be whitish. It is known that the value of a dark current component varies with the exposure condition and the sensor temperature. It is, thus, desirable to adaptively detect a dark current component in image capturing and remove the dark current component based on the detection result.

There are methods of providing a pixel region which is shielded from light so as not to receive light, which is called a light shielding region (optical black (OB) region, hereinafter, referred to as an OB region), in a peripheral portion of an image sensor. A method is widely known in which in image capturing, pixel values in the OB region are read together with pixel values in the imaging region (effective pixel region), the magnitude or distribution of the dark current component is estimated from the OB region pixel values, and correction is made by subtracting the estimated result from the pixel values in the imaging region.

In the meantime, in recent years, there has been known high dynamic range (HDR) (hereinafter, referred to as HDR) image capturing to expand the image capturing dynamic range of an image sensor. As one of the several methods for HDR image capturing, Japanese Patent Application Laid-Open No. 2021-129144 discusses an image sensor that performs image capturing under exposure conditions (exposure time and gain coefficient) set for each of a plurality of small regions into which the imaging region of the sensor is divided. Hereinafter, for convenience, such an image capturing method is referred to as “region-by-region exposure image capturing”, and a sensor capable of performing region-by-region exposure image capturing is referred to as “region-by-region exposure sensor”.

To remove the foregoing dark current component with a region-by-region exposure sensor, it is necessary to prepare N kinds of dark current component information for N (N≥2) kinds of exposure condition used by the sensor. Japanese Patent Application No. 2021-99683 discloses a method of calculating a ratio determined from at least one of an exposure time ratio and a gain ratio between an exposure condition for an OB region and the N kinds of exposure condition, and calculating and using N kinds of dark current component estimation value from the ratio.

Japanese Patent Application No. 2021-99683 describes obtaining N kinds of dark current component estimation value, but an actual dark current component may deviate from the estimation value. As a result, the brightness may vary slightly between blocks because of inappropriate removal of the dark current component in each block, making the boundary between the blocks conspicuous.

### SUMMARY

In view of the foregoing issue, the present disclosure is directed to output of image data from which a dark current component is appropriately removed based on each exposure condition used by a region-by-region exposure sensor.

According to an aspect of the present disclosure, an image processing apparatus that corrects image data captured with an image sensor capable of setting for each of regions at least one exposure condition including at least one of a gain value per pixel and an exposure time includes an acquisition unit configured to acquire a dark current component in a light shielding region of the image sensor for each of the at least one exposure condition changed at predetermined intervals, and a correction unit configured to correct the image data using the dark current component acquired by the acquisition unit.

Further features of the present disclosure will become apparent from the following description of exemplary embodiments with reference to the attached drawings.

### BRIEF DESCRIPTION OF THE DRAWINGS

FIG. 1 illustrates a schematic configuration example of an imaging apparatus.

FIG. 2 illustrates each region of an image sensor unit.

FIG. 3 illustrates a configuration example of a dark current correction unit.

FIG. 4 is a flowchart illustrating a procedure of processing performed by a dark-current-component removal unit.

FIG. 5 illustrates each region of an image sensor unit according to one or more aspects of the present disclosure.

FIG. 6 illustrates a configuration example of a dark current correction unit according to one or more aspects of the present disclosure.

### DESCRIPTION OF THE EMBODIMENTS

Hereinafter, exemplary embodiments of techniques of the present disclosure will be described in detail with reference to the accompanying drawings. The following exemplary embodiments do not limit the techniques of the present disclosure according to the scope of the claims, and not all combinations of features described in the exemplary embodiments are used for solving means in the techniques of the present disclosure. Like numbers refer to like components or piece of processing in the description.

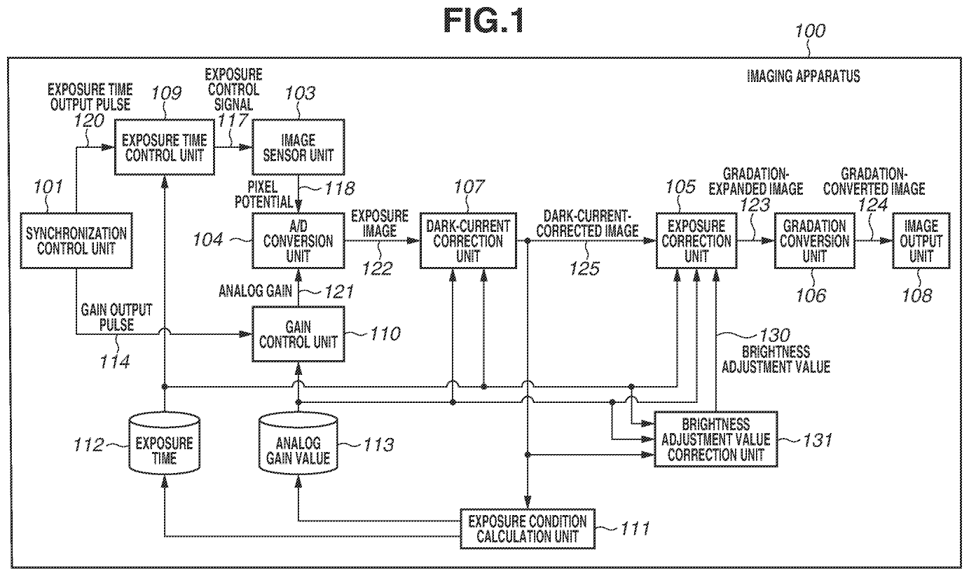

A first exemplary embodiment will be described. FIG. 1 is a block diagram illustrating a schematic configuration example of an imaging apparatus 100 according to the present exemplary embodiment. The imaging apparatus 100 according to the present exemplary embodiment is an image processing apparatus that also includes various components of a typical imaging apparatus, but for a simple illustration and description, FIG. 1 illustrates only main units according to the present exemplary embodiment.

The imaging apparatus 100 includes a synchronization control unit 101, an image sensor unit 103, an analog-digital (A/D) conversion unit 104, an exposure correction unit 105, a gradation conversion unit 106, a dark-current correction unit 107, and an image output unit 108. The imaging apparatus 100 further includes an exposure time control unit 109, a gain control unit 110, an exposure condition calculation unit 111, and a brightness adjustment value correction unit 131.

First, the outline of each component of the imaging apparatus 100 according to the present exemplary embodiment will be described starting with the image sensor unit 103.

The image sensor unit 103 has an imaging region. The imaging region consists of an optical black (OB) region as a light shielding region, and an effective pixel region, in which actual images are captured. The effective pixel region is divided into a plurality of regions called pixel blocks. Details will be described below. Each pixel block (region) of the image sensor unit 103 can be driven, and has a function of performing an exposure operation (charge accumulation) during an exposure time different from other regions. The pixel blocks will be described in detail below. In the present exemplary embodiment, the image sensor unit 103 with an exposure time for each region set with an exposure control signal 117 supplied from the exposure time control unit 109 performs exposure during the exposure time set for each region. The exposure control signal 117 is a signal for setting an exposure time for each region of the image sensor unit 103. The image sensor unit 103 reads as a pixel potential 118 a charge accumulated in each pixel during the exposure time for the region set with the exposure control signal 117, and outputs the pixel potential 118 to the A/D conversion unit 104.

The A/D conversion unit 104 converts the pixel potential 118 read from the image sensor unit 103 into a digital value through A/D conversion. In the present exemplary embodiment, an analog gain 121 corresponding to each of the above-described regions is set in the A/D conversion unit 104 by the gain control unit 110. The A/D conversion unit 104 multiplies the pixel potential 118 output from the image sensor unit 103 by the analog gain 121 for each region, and then performs A/D conversion of the result into a digital value. Hereinafter, an image formed of a digital signal obtained through the multiplication by the analog gain 121 for each region and then the A/D conversion performed by the A/D conversion unit 104 is referred to as an exposure image 122. The exposure image 122 output from the A/D conversion unit 104 is sent to the dark-current correction unit 107. Then, a dark-current-corrected image 125 through the removal of the dark current component performed by the dark-current correction unit 107 is sent to the brightness adjustment value correction unit 131, the exposure condition calculation unit 111, and the exposure correction unit 105.

The exposure condition calculation unit 111 calculates and updates an exposure time 112 and an analog gain value 113 for each region based on the exposure image 122 to obtain an optimal imaging condition. Specifically, the exposure condition calculation unit 111 calculates a histogram of the pixel values in each pixel block based on a brightness distribution of the exposure image 122. Then, if the pixel values tend to be distributed on the bright side, the exposure condition calculation unit 111 changes (updates) the exposure time 112 and the analog gain value 113 for each region to respective setting values for darker imaging. If the pixel values tend to be distributed on the dark side, the exposure condition calculation unit 111 changes (updates) the exposure time 112 and the analog gain value 113 for each region to respective setting values for brighter imaging. The value of the exposure time 112 for each region is sent to the exposure time control unit 109 and the exposure correction unit 105. The analog gain value 113 for each region is sent to the gain control unit 110 and the exposure correction unit 105. The value of the exposure time 112 and the analog gain value 113 for each region are also sent to the brightness adjustment value correction unit 131 and the dark-current correction unit 107.

The brightness adjustment value correction unit 131 calculates a correction value for the exposure time 112 and the analog gain value 113. Then, the brightness adjustment value correction unit 131 multiplies a brightness adjustment value 130 obtained from the exposure time 112 and the analog gain value 113 by the correction value to update the brightness adjustment value 130, and outputs the updated brightness adjustment value 130 to the exposure correction unit 105.

Here, the concept of the brightness adjustment value 130 will be described. The brightness adjustment value 130 is a value representing a conversion factor for converting a signal value obtained through imaging under an exposure condition for each region into a signal value obtained through imaging under a reference exposure condition.

For example, the reference exposure condition is an exposure condition A, and in the exposure condition A, the exposure time is 1/30 seconds and the analog gain is 8 times. Further, an exposure condition with an exposure time of 1/60 seconds and an analog gain of 2 times, different from the reference exposure condition A, is referred to as an exposure condition B. A signal value when a certain region C undergoes imaging under the exposure condition B is denoted by SB. In the relationship between the exposure condition A and the exposure condition B, the exposure time and analog gain of the exposure condition B is ½ and ¼ of those of the exposure condition A, respectively. In other words, when a signal value obtained when the region C undergoes imaging under the reference exposure condition is SA, the following relationship is established between SA and SB.

$$SB = 1 / 2 \times 1 / 4 \times SA = 1 / 8 \times SA$$

Thus, SA and SB have the following relationship. The value obtained by multiplying the above value by 8 is a brightness adjustment value corresponding to the region C.

$$SA = 8 \times SB$$

The synchronization control unit 101 generates an exposure time output pulse 120 and a gain output pulse 114 which are synchronized with each other. The synchronization control unit 101 outputs the generated exposure time output pulse 120 to the exposure time control unit 109. The synchronization control unit 101 outputs the generated gain output pulse 114 to the gain control unit 110. Thus, the synchronization control unit 101 synchronously controls the processing of the exposure time control unit 109 and the processing of the gain control unit 110. The exposure time output pulse 120 is a signal for controlling the timing at which the exposure time control unit 109 outputs the exposure control signal 117 to the image sensor unit 103. The exposure time control unit 109 outputs the exposure control signal 117 to the image sensor unit 103 based on the exposure time output pulse 120, thereby changing the exposure time for each arbitrary pixel block of the image sensor unit 103. The gain output pulse 114 is a signal for controlling the timing at which the gain control unit 110 outputs the analog gain 121 to the A/D conversion unit 104. The gain control unit 110 outputs the analog gain 121 to the A/D conversion unit 104 based on the gain output pulse 114, thereby changing the gain by which the pixel potential 118 is multiplied for each arbitrary pixel block. As described above, in the present exemplary embodiment, the synchronization control unit 101 synchronizes the exposure time control unit 109 and the gain control unit 110 to perform operation control, allowing the exposure image 122 with the appropriately changed exposure time and analog gain for each pixel block of the image sensor unit 103 to be output.

The exposure time control unit 109 generates the exposure control signal 117 for each region based on the exposure time output pulse 120 and the value of the exposure time 112 for each region, and outputs the generated exposure control signal 117 to the image sensor unit 103. Thus, the exposure time corresponding to the exposure time 112 for each region is set for the image sensor unit 103 at appropriate timing.

The gain control unit 110 outputs the analog gain value 113 for each region to the A/D conversion unit 104 as the analog gain 121 with respect to the pixel potential 118 for each region of the image sensor unit 103 in synchronization with the pulse timing of the gain output pulse 114. Thus, in the A/D conversion unit 104, the analog gain 121 corresponding to the pixel potential 118 for each region is multiplied, and then A/D conversion is performed. The data subjected to the A/D conversion is transmitted to the dark-current correction unit 107 as the exposure image 122 for each region.

The dark-current correction unit 107 performs processing on information on an optical black (OB) region of the exposure image 122 for each region transmitted from the A/D conversion unit 104 by exposure condition separately. Then, under which condition the exposure image 122 for each region to be input has undergone imaging is determined by the exposure time 112 for each region and the analog gain value 113 for each region, and the dark current component is removed based on dark current component information obtained under each exposure condition. The dark-current-corrected image 125 through the removal of the dark current component is sent to the brightness adjustment value correction unit 131, the exposure condition calculation unit 111, and the exposure correction unit 105. An operation of the dark-current correction unit 107 will be described in detail below.

The exposure correction unit 105 performs gradation expansion processing on the dark-current-corrected image 125 for each region transmitted from the dark-current correction unit 107 based on the brightness adjustment value 130 to generate a gradation-expanded image 123. For example, under which condition the exposure image 122 for each region to be input has undergone imaging is determined by the exposure time 112 for each region and the analog gain value 113 for each region, and the exposure image 122 for each region is corrected using the brightness adjustment value 130 corresponding to the condition. The exposure correction unit 105 generates the gradation-expanded image 123 represented by 17 bits through gradation expansion processing on the exposure image 122 for each region represented by 10 bits, for example. The generated gradation-expanded image 123 is sent to the gradation conversion unit 106.

The gradation conversion unit 106 performs gradation conversion on the gradation-expanded image 123, and outputs a gradation-converted image 124 to the image output unit 108. In the present exemplary embodiment, the gradation conversion is processing for generating, for example, an 11-bit gradation-converted image 124 through gamma conversion of the 17-bit gradation-expanded image 123. The gradation conversion processing according to the present exemplary embodiment is performed to suppress the data rate in the subsequent processing. In the present exemplary embodiment, the bit lengths of the exposure image 122 and the gradation-converted image 124 are 10 bits and 11 bits, respectively, but these bit lengths are merely examples, and the present disclosure is not limited to these.

The image output unit 108 outputs the gradation-converted image 124 to the following component(s) of the imaging apparatus 100 or to the outside.

### <Configuration of Image Sensor Unit>

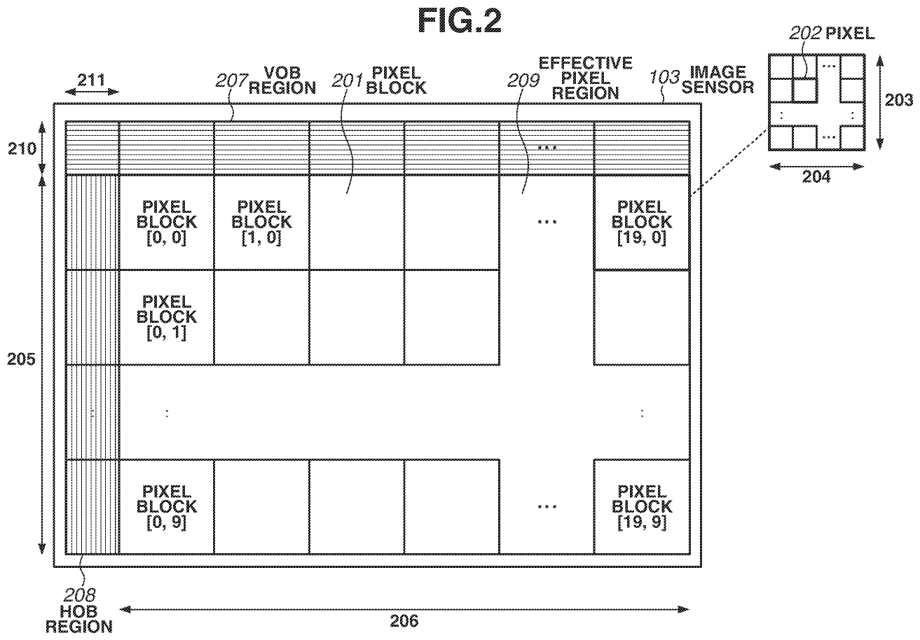

FIG. 2 illustrates a configuration example of the image sensor unit 103. The imaging region of the image sensor unit 103 consists of the OB region as the light shielding region and an effective pixel region 209, in which actual images are captured. The OB region consists of a vertical OB (VOB) region 207 represented in a horizontal stripe pattern and a horizontal OB (HOB) region 208 represented in a vertical stripe pattern. The effective pixel region 209 includes a plurality of pixel blocks 201. Each of the pixel blocks 201 further includes a plurality of pixels 202. In the present exemplary embodiment, it is premised that the number of pixels in the directions of a width 206 (horizontal line directions) of the effective pixel region 209 of the image sensor unit 103 is 2,000, and the number of pixels in the directions of a height 205 is 1,000 (i.e., the number of horizontal lines in the vertical directions is 1,000). The number of pixels in the directions of a width 204 (horizontal line directions) of each pixel block 201 is 100, and the number of pixels in the directions of a height 203 is 100 (corresponding to 100 horizontal lines in the vertical directions). In this case, the number of the pixel blocks 201 in the effective pixel region 209 of the image sensor unit 103 is 20 in the horizontal directions and 10 in the vertical directions. Pixel blocks [0, 0] to [19, 9] described in the pixel blocks 201 in FIG. 2 represent the positions of the respective pixel blocks 201 in the effective pixel region 209. Values in a bracket [ ] are horizontal and vertical indices of the pixel block in the effective pixel region 209. In FIG. 2, for example, the pixel block 201 positioned at the upper right of the image sensor unit 103 is the pixel block [19, 0]. A set of pixel blocks represented by an index in the vertical directions is referred to as a block row. Specifically, a block row N is composed of the pixel blocks [0, N] to [19, N]. For example, a block row 5 is composed of the pixel blocks [0,5] to [19,5].

In the present exemplary embodiment, the number of pixels in a height 210 of the VOB region 207 is 64, and the number of pixels in a width 211 of the HOB region 208 is 64.

The sizes (the numbers of pixels in the vertical directions and the horizontal directions) of the image sensor unit 103 and each pixel block 201 are not limited to the above-described examples. The shape and aspect ratio of each pixel 202 are not so limited, and each pixel 202 may be, for example, a rectangle instead of a square. Further, each pixel block 201 may consist of only one pixel 202.

In the present exemplary embodiment, the exposure time and the analog gain for each pixel block 201 can be controlled.

Here, the exposure time corresponds to a time during which a charge is accumulated in a pixel (light receiving element) of the image sensor unit 103 in imaging. For example, suppose that the amount of light incident on the image sensor unit 103 is constant and the charge of a pixel is not saturated, the pixel potential 118 increases with a longer exposure time, allowing brighter imaging. Specifically, when the amount of incident light is constant and the saturation of the charge of a pixel is not considered, for example, in comparison between cases of 1/480 seconds and 1/30 seconds as exposure times, the image captured at an exposure time of 1/30 seconds can be brighter.

The analog gain 121 is a gain by which the pixel potential 118 is multiplied in the A/D conversion unit 104 in imaging. Thus, a greater analog gain value results in a greater digital pixel value (digital value obtained through the A/D conversion after the multiplication by the gain) output from the A/D conversion unit 104.

Returning to FIG. 1, a configuration and operation of the imaging apparatus 100 according to the present exemplary embodiment will be described in detail.

The image sensor unit 103 performs imaging with the exposure time for each of the pixel blocks 201 controlled based on the exposure control signal 117. Then, the image sensor unit 103 outputs the pixel potential 118 corresponding to a charge accumulated in each pixel.

The A/D conversion unit 104 multiplies the pixel potential 118 output from the image sensor unit 103 by the analog gain 121 set for each pixel block 201 of the image sensor unit 103, and then performs digital conversion to output the exposure image 122. In the present exemplary embodiment, the exposure image 122 is represented by a 10-bit digital value. The analog gain 121 can take four values of 1×, 2×, 4×, and 8× as gain values, for example.

### <Operation of Setting Exposure Conditions for OB Region>

An operation of setting exposure conditions for the OB region will now be described. The synchronization control unit 101 according to the present exemplary embodiment generates the exposure time output pulse 120 and the gain output pulse 114 that are synchronized with each other for the OB region as well. However, in the present exemplary embodiment, one common set of exposure conditions is set for the OB region. The exposure time output pulse 120 and the gain output pulse 114 for the OB region are, thus, output only at the head of each frame. The exposure time control unit 109 outputs the exposure control signal 117 to the image sensor unit 103 based on the exposure time output pulse 120, thereby changing the exposure time for each arbitrary pixel block of the image sensor unit 103. The gain control unit 110 outputs the analog gain 121 to the A/D conversion unit 104 based on the gain output pulse 114, thereby changing the gain by which the pixel potential 118 for each arbitrary pixel block is multiplied.

In the present exemplary embodiment, it is premised that an exposure time of 1/30 seconds, 1/120 seconds, 1/480 seconds, 1/1,920 seconds, or 1/7,680 seconds is applied to each pixel block 201 of the effective pixel region 209. The exposure time for the OB region is set to the longest exposure time selected from among the exposure times applicable to the effective pixel region 209. Specifically, when the exposure time control unit 109 receives the exposure time output pulse 120 corresponding to the OB region, the exposure time control unit 109 selects an exposure time of 1/30 seconds and outputs the exposure control signal 117 to the image sensor unit 103.

In the present exemplary embodiment, the four kinds of analog gain 1×, 2×, 4×, and 8× are available gain values as described above. The gain value for the OB region is set by changing the gain value to take a value 1×, 2×, 4×, or 8× by frame. Specifically, the gain control unit 110 changes the value of the analog gain 121 for the OB region of the image sensor unit 103 by the frame in synchronization with the pulse timing of the gain output pulse 114, and outputs the changed value to the A/D conversion unit 104. As a result, for example, an image at an exposure time of 1/30 seconds and an analog gain of 1× as exposure conditions for the OB region in the M-th frame is output as the exposure image 122 from the A/D conversion unit 104 to the dark-current correction unit 107. In the next (M+1)-th frame, an image at an exposure time of 1/30 seconds and an analog gain of 2× as exposure conditions for the OB region, and then in the (M+2)-th frame, an image at an exposure time of 1/30 seconds and an analog gain of 4× as exposure conditions for the OB region are output. In the (M+3)-th frame, an image at an exposure time of 1/30 seconds and an analog gain of 8× as exposure conditions for the OB region is output, but in the (M+5)-th frame, an image at an exposure time of 1/30 seconds and an analog gain of 1× as exposure conditions for the OB region is output again. Which gain is set for the OB region in which frame is determined by information indicated by the analog gain value 113, and the information is shared with the dark-current correction unit 107.

### <Operation of Dark-Current Correction Unit>

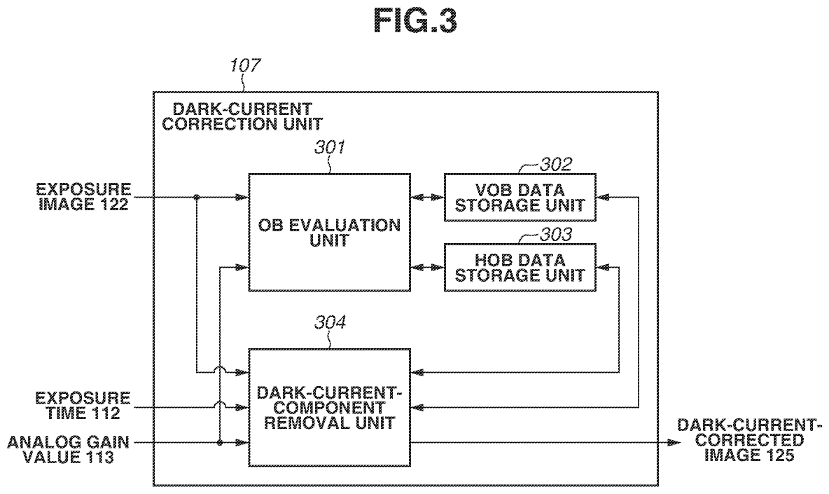

An operation of the dark-current correction unit 107 will now be described with reference to a drawing. FIG. 3 illustrates a configuration example of the dark-current correction unit 107.

The dark-current correction unit 107 includes an OB evaluation unit 301, a VOB data storage unit 302, an HOB data storage unit 303, and a dark-current-component removal unit 304.

The OB evaluation unit 301 extracts dark current components from the VOB region 207 and the HOB region 208 of the exposure image 122 in each frame. The pixel values of the OB region include a random noise component, so that statistical processing is applied to extract dark current components. Typical examples of statistical processing include averaging, weighted averaging, and median value calculation. In the VOB region 207, statistical processing is performed in the vertical directions. As illustrated in FIG. 2, since the height 210 of the VOB region 207 consists of 64 pixels, statistical processing is performed on the 64 pixels in the vertical directions to obtain a representative value to extract a dark current component in the horizontal directions. Similarly, since the width 211 of the HOB region 208 consists of 64 pixels, statistical processing is performed on the 64 pixels in the horizontal directions to obtain a representative value to extract a dark current component in the vertical directions. Alternatively, the statistical processing can be performed by grouping the pixels by pixel component as appropriate. For example, in a pixel configuration of a Bayer pattern which is a pattern of red (R), blue (B), green in the red row (Gr), and green in the blue row (Gb), R pixels and Gb pixels are alternately arranged in the vertical directions. In this case, it is desirable that the statistical processing be performed separately between the R pixels and the Gb pixels. If different vertical signal lines are used between the same color channels, it is desirable to perform statistical processing separately even if between the same color channels. For example, if different vertical signal lines are used between the R (Gr/Gb/B) pixels in even-numbered rows and the R (Gr/Gb/B) pixels in odd-numbered rows, it is suitable to perform different statistical processing between the R (Gr/Gb/B) pixels in the even-numbered rows and the R (Gr/Gb/B) pixels in the odd-numbered rows. Similarly, if a floating diffusion (FD) is shared with a plurality of pixels, it is desirable to perform different statistical processing for each pixel having different symmetry of the arrangement of the pixel readout circuit. Further, the dark current component in the vertical directions is corrected with the dark current component in the horizontal directions so that a dark current component is not doubly subtracted in the vertical directions and the horizontal directions.

The dark current components are extracted after which of the values 1×, 2×, 4×, and 8× the analog gain value for the OB region of the frame being processed is determined based on the analog gain value 113. Then, the extracted dark current component information is written from the OB evaluation unit 301 to the entries corresponding to the analog gain value in the VOB data storage unit 302 and the HOB data storage unit 303. Further, the OB evaluation unit 301 reads the dark current component information corresponding to the stored analog gain value from the VOB data storage unit 302 and the HOB data storage unit 303, and performs temporally statistical processing on the dark current component information together with the dark current component information on the frame being processed.

For example, as described above, the dark current component information generated and stored in the M-th frame (analog gain of 1×) is read in the (M+5)-th frame (analog gain of 1×), and processing, such as temporal averaging, is performed, and the result is stored again. This makes it possible to further reduce the influence of random noise on the dark current component. In addition, the dark current generally varies depending on the temperature. Thus, the influence of the temperature variation between frames can be reduced by obtaining the temporal average.

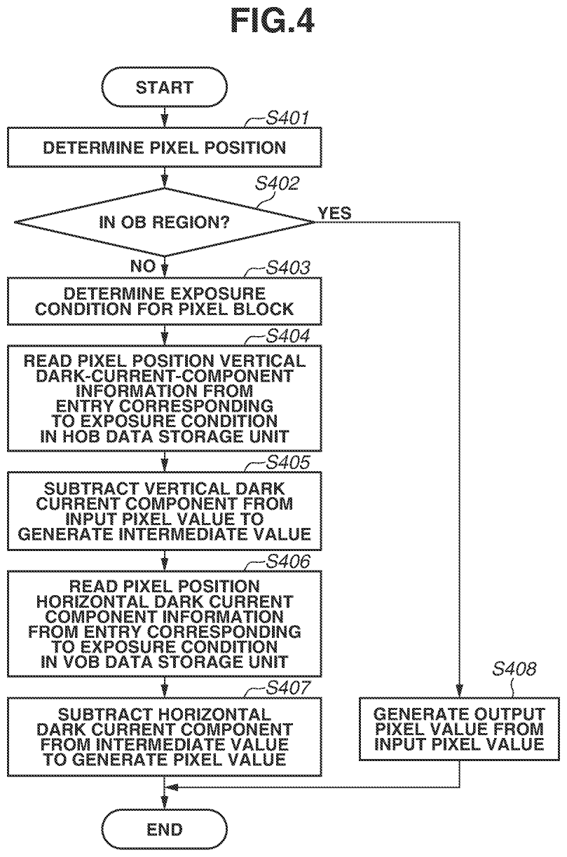

The dark-current-component removal unit 304 creates the dark-current-corrected-image 125 by subtracting the dark current component information from the input exposure image 122. An operation of the dark-current-component removal unit 304 will be described with reference to a drawing. FIG. 4 is a flowchart illustrating a procedure of processing performed by the dark-current-component removal unit 304. Note that the symbol “S” in the description of each piece of processing means a step in the flowchart.

In step S401, the dark-current-component removal unit 304 determines the pixel positions of the currently input exposure image 122. Then, the corresponding pixel block position is determined through calculation.

In step S402, it is determined whether the pixel block position is in the OB region. If the pixel block position is in the OB region (YES in step S402), the processing proceeds to step S408. If the pixel block position is not in the OB region (NO in step S402), i.e., if the pixel block position is in the effective pixel region 209, the processing proceeds to step S403.

In step S408, the pixel values of the input exposure image 122 are used as the pixel values of the output image without change, and the processing is terminated. The output pixel values are the pixel values of the dark-current-corrected image 125.

In step S403, the dark-current-component removal unit 304 determines the exposure condition applied to the pixel block based on the determined pixel block positions. For example, in FIG. 2, it is premised that the analog gain value for the pixel block [0, 0] is 1 time and the analog gain value for the pixel block [1, 0] is 2 times.

In step S404, the dark-current-component removal unit 304 reads dark current component information in the vertical directions at the pixel positions from the HOB data storage unit 303 using the determined exposure conditions for the pixel block.

For example, if the pixel data currently being processed belongs to the pixel block [0, 0], the dark-current-component removal unit 304 refers to the entry corresponding to an analog gain value of 1× in the HOB data storage unit 303. Then, the dark current component information in the vertical directions corresponding to the pixel positions belonging to the pixel block [0, 0] is read.

In step S405, the dark-current-component removal unit 304 subtracts the read dark current component information in the vertical directions corresponding to the pixel positions from the pixel values of the input exposure image 122 to generate an intermediate value.

In step S406, the dark-current-component removal unit 304 reads dark current component information in the horizontal directions at the pixel positions from the VOB data storage unit 302 using the determined exposure conditions for the pixel block.

For example, if the pixel data currently being processed belongs to the pixel block [0, 0], the dark-current-component removal unit 304 refers to the entry corresponding to the analog gain value of 1× in the VOB data storage unit 302. Then, the dark current component information in the horizontal directions corresponding to the pixel positions belonging to the pixel block [0, 0] is read.

In step S407, the dark-current-component removal unit 304 subtracts the read dark current component information in the horizontal directions corresponding to the pixel positions from the intermediate value obtained in step S405, and generates output pixel values. As described above, the output pixel values are the pixel values of the dark-current-corrected image 125.

In FIG. 4, the vertical dark current component is corrected first using the HOB data, and then the horizontal dark current component is corrected using the VOB data, but this order may be reversed. If the vertical dark current distribution and the horizontal dark current distribution are different in size, it is desirable to select the dark current component with the smaller distribution first. For example, for a larger horizontal shading due to the column amplifier, it is desirable to perform correction using the HOB data first. On the other hand, for a larger vertical shading due to the influence of horizontal smear or another source, it is desirable to perform correction using the VOB data first.

The exposure correction unit 105 in the subsequent steps performs brightness correction processing and other processing using the dark-current-corrected image 125.

In the present exemplary embodiment, the example has been described in which the analog gain is switched by frame in sequence, but the switching interval is not limited to by frame as long as the interval at which the analog gain is switched is by frame. However, in view of the statistical nature in the time direction, it is desirable to switch the analog gain by frame. In addition, the example in which the analog gains are equally switched in order has been described in the present exemplary embodiment. If there is an analog gain that is not used in an actual image capturing scene, it may be desirable to weight the frequency of setting. However, even in such a case, it is desirable to avoid setting an analog gain that is not used as an exposure condition for the OB region because a case cannot be handled where an exposure condition for the effective region is suddenly changed.

As described above, according to the present exemplary embodiment, by obtaining a dark current component for each exposure condition used by a region-by-region exposure sensor, image data from which the dark current component is appropriately removed according to the exposure condition can be output. Consequently, this prevents a boundary between blocks from being made conspicuous due to a slight difference in brightness between the blocks caused by a dark current component not appropriately removed for each block.

An imaging apparatus according to a second exemplary embodiment will be described with reference to drawings.

In the first exemplary embodiment, exposure conditions for the OB region are set once for one frame. However, by dividing the OB region in accordance with the size of the effective pixel region 209, it is possible to set exposure conditions for the OB region using the method of setting exposure conditions for the effective pixel region 209 as it is. Further, by performing the setting operation for the OB region at the same timing as for the effective pixel region 209, a minute fluctuation of an electric signal caused by the setting operation is reflected in the OB region, and thus it is expected that noise can be more effectively removed.

In the second exemplary embodiment, such a configuration and operation will be described.

### <Configuration of Image Sensor Unit 103 in Second Exemplary Embodiment>

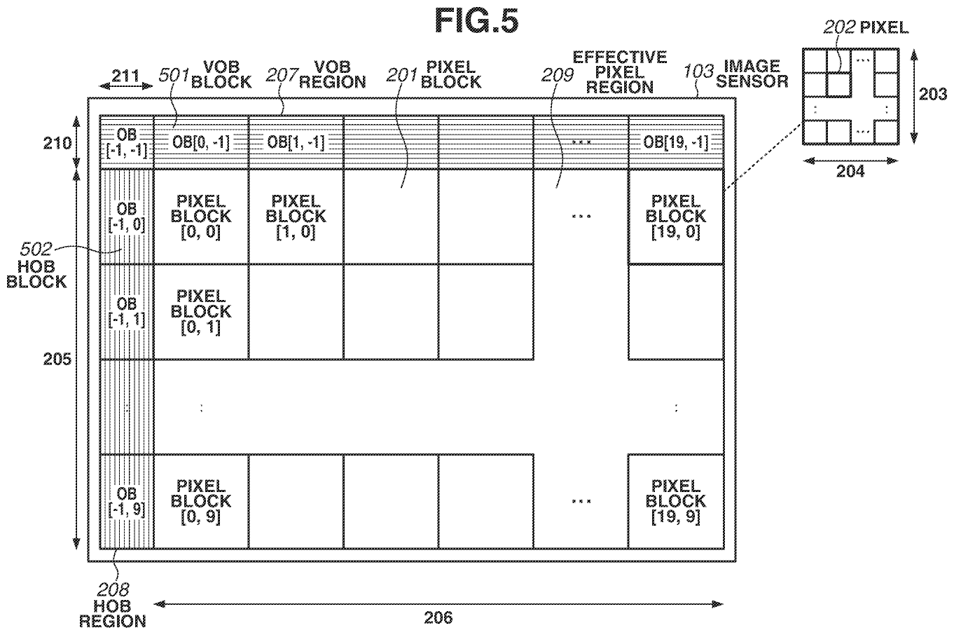

FIG. 5 illustrates a configuration example of an image sensor unit 103 according to the second exemplary embodiment. The imaging region of the image sensor unit 103 consists of an OB region as a light shielding region and an effective pixel region 209, in which actual images are captured. The OB region consists of a VOB region 207 represented in a horizontal stripe pattern and an HOB region 208 represented in a vertical stripe pattern. The effective pixel region 209 includes a plurality of pixel blocks 201. Each pixel block 201 includes a plurality of pixels 202. In the present exemplary embodiment, it is premised that the number of pixels in the directions of a width 206 (horizontal line directions) of the effective pixel region of the image sensor unit 103 is 2,000, and the number of pixels in the directions of a height 205 is 1,000 (i.e., the number of horizontal lines in the vertical direction is 1,000). The number of pixels in the directions of a width 204 (horizontal line directions) of each pixel block 201 is 100, and the number of pixels in the directions of a height 203 is 100 (for 100 horizontal lines in the vertical directions). In this case, the number of the pixel blocks 201 in the effective pixel region 209 of the image sensor unit 103 is 20 in the horizontal directions and 10 in the vertical directions. Pixel blocks [0, 0] to [19, 9] described in the pixel blocks 201 in FIG. 5 represent the positions of the respective pixel blocks 201 in the effective pixel region 209. Values in a bracket [ ] are horizontal and vertical indices of the pixel block in the effective pixel region 209. In FIG. 5, for example, the pixel block 201 positioned at the upper right of the image sensor unit 103 is the pixel block [19, 0]. A set of pixel blocks represented by an index in the vertical directions is referred to as a block row. Specifically, a block row N is composed of the pixel blocks [0, N] to [19, N]. For example, a block row 5 is composed of the pixel blocks [0, 5] to [19, 5].

In the present exemplary embodiment, the VOB region 207 has a configuration in which VOB blocks 501 that have the same width into which the VOB region 207 is divided as the width of the pixel blocks of the effective pixel region described above are arranged in the horizontal directions. The VOB blocks OB [−1, −1] to OB [19, −1] constitute the VOB region 207. The HOB region 208 has a configuration in which HOB blocks 502 that have the same height into which the HOB region 208 is divided as the height of the pixel blocks of the effective pixel region described above are arranged in the vertical directions. The HOB blocks OB[−1, 0] to OB [−1, 9] constitute the HOB region 208. The VOB blocks and the HOB blocks are collectively referred to as the OB block. In the present exemplary embodiment, the number of pixels in a height 210 of the VOB region 207 is 64, and the number of pixels in a width 211 of the HOB region 208 is 64. Dividing the OB region into the same width and height as those of the effective pixel region in this way allows exposure times and analog gain values applied to the OB region to be changed using the same method as the method used for the pixel blocks of the effective pixel region.

The sizes (the numbers of pixels in the vertical directions and the horizontal directions) of the image sensor unit 103, the pixel blocks 201, the VOB blocks 501, and the HOB blocks 502 are not limited to the above-described examples. The shape and aspect ratio of each pixel 202 are not limited, and each pixel 202 may be, for example, a rectangle instead of a square. Further, each pixel block 201 may consist of only one pixel 202.

In the present exemplary embodiment, the exposure time and the analog gain for each pixel block 201, each VOB block 501, and each HOB block 502 can be controlled.

Returning to FIG. 1, a configuration and operation of the imaging apparatus 100 according to the present exemplary embodiment will be described in detail.

The operations of the image sensor unit 103 and the A/D conversion unit 104 are the same as those in the first exemplary embodiment, and thus the description thereof will be omitted. In the present exemplary embodiment, the analog gain 121 can also take four values of 1×, 2×, 4×, and 8× as gain values, for example.

### <Setting Operation of Exposure Conditions for OB Region in Second Exemplary Embodiment>

An operation of setting exposure conditions for the OB region will be described. The synchronization control unit 101 according to the present exemplary embodiment generates the exposure time output pulse 120 and the gain output pulse 114 that are also synchronized with each other for the OB region as well. The exposure time control unit 109 outputs the exposure control signal 117 to the image sensor unit 103 based on the exposure time output pulse 120, thereby changing the exposure time for each arbitrary pixel block including the OB region of the image sensor unit 103. The gain control unit 110 outputs the analog gain 121 to the A/D conversion unit 104 based on the gain output pulse 114, thereby changing the gain by which the pixel potential for each arbitrary pixel block including the OB region is multiplied.

In the present exemplary embodiment, it is premised that an exposure time of 1/30 seconds, 1/120 seconds, 1/480 seconds, 1/1,920 seconds, or 1/7,680 seconds is applied to each pixel block 201 of the effective pixel region 209. The exposure time for the OB region is set to the longest exposure time selected from among the exposure times applicable to the effective pixel region 209. Specifically, when the exposure time control unit 109 receives the exposure time output pulse 120 corresponding to the OB region, the exposure time control unit 109 selects an exposure time of 1/30 seconds and outputs the exposure control signal 117 to the image sensor unit 103.

In the present exemplary embodiment, four kinds of analog gain 1×, 2×, 4×, and 8× are available gain values as described above. The gain value for the OB region is set by changing the gain value to take a value 1×, 2×, 4×, or 8× by frame. At this time, the setting operation is performed with the switching of an HOB block in the vertical directions. In other words, the gain control unit 110 outputs the analog gain 121 for the OB region of the image sensor unit 103 to the A/D conversion unit 104 at pulse timing of the gain output pulse 114 being output for the effective pixel region every time a pixel block is switched. At this time, an analog gain value is repeatedly used as the set value in a frame. By making the operations for the OB region and the effective pixel region as similar as possible, it is expected that the dark current correction using the OB region will be improved.

For example, an image at an exposure time of 1/30 seconds and an analog gain of 1× as exposure conditions for the OB region in the M-th frame is output as the exposure image 122 from the A/D conversion unit 104 to the dark-current correction unit 107. In the next (M+1)-th frame, an image at an exposure time of 1/30 seconds and an analog gain of 2× as exposure conditions for the OB region, and then in the (M+2)-th frame, an image at an exposure time of 1/30 seconds and an analog gain of 4× as exposure conditions for the OB region are output. In the (M+3)-th frame, an image at an exposure time of 1/30 seconds and an analog gain of 8× as exposure conditions for the OB region is output, but in the (M+5)-th frame, an image at an exposure time of 1/30 seconds and an analog gain of 1× as exposure conditions for the OB region is output again. Which gain is set for the OB region in which frame is determined by information indicated by the analog gain value 113, and the information is shared with the dark-current correction unit 107.

In the above description, the example has been described in which an analog gain value for the OB region is repeatedly used as the set value in a frame, but different analog gain values may be set in different OB blocks in a frame. In this case, the analog gain value is switched so that all OB data with the analog gains of 1×, 2×, 4×, and 8× can be acquired for each OB block in the OB region in four frames of the M-th to the (M+3)-th frames. Then, the dark current correction can be performed using the OB data on the OB region with the same exposure conditions as those applied to the pixel block in the effective pixel region.

The other content is the same as that in the first exemplary embodiment, and thus the description thereof will be omitted.

As described in the second exemplary embodiment, the division of the OB region according to the size of the effective pixel region allows setting of exposure conditions for the OB region using the method of setting exposure conditions for the effective pixel region as it is. Further, by performing the setting operation for the OB region at the same timing as for the effective pixel region, a minute fluctuation of an electric signal caused by the setting operation is reflected in the OB region, providing more effective removal of noise.

An imaging apparatus according to a third exemplary embodiment will be described with reference to drawings.

In the first exemplary embodiment, the exposure time for the OB region is set to the longest exposure time selected from among the exposure times applicable to the effective pixel region 209. However, to remove the dark current more effectively in accordance with the exposure conditions, it is desirable to change the exposure time as well.

In the third exemplary embodiment, such a configuration and operation will be described.

### <Setting Operation for Exposure Conditions for OB Region in Third Exemplary Embodiment>

An operation of setting exposure conditions for an OB region in the third exemplary embodiment will be described with reference to FIG. 1.

A synchronization control unit 101 according to the present exemplary embodiment generates the exposure time output pulse 120 and the gain output pulse 114 that are synchronized with each other for the OB region as well. However, in the present exemplary embodiment, one common set of exposure conditions is set for the OB region. The exposure time output pulse 120 and the gain output pulse 114 for the OB region are, thus, output only at the head of each frame.

The exposure time control unit 109 outputs the exposure control signal 117 to the image sensor unit 103 based on the exposure time output pulse 120, thereby changing the exposure time for each arbitrary pixel block of the image sensor unit 103. The gain control unit 110 outputs the analog gain 121 to the A/D conversion unit 104 based on the gain output pulse 114, thereby changing the gain by which the pixel potential for each arbitrary pixel block is multiplied.

In the present exemplary embodiment, it is premised that an exposure time of 1/30 seconds, 1/120 seconds, 1/480 seconds, 1/1,920 seconds, or 1/7,680 seconds is applied to each pixel block 201 of the effective pixel region 209. The exposure time for the OB region is set by selecting an exposure time applicable to the effective pixel region 209 in sequence. As in the first exemplary embodiment, four kinds of analog gain 1×, 2×, 4×, and 8× are available gain values. It is premised that an exposure time of 1/30 seconds and an analog gain of 1× are selected in the M-th frame. In this case, the exposure time for the OB region is set to an exposure time of 1/30 seconds common to the consecutive M-th, (M+1)-th, (M+2)-th, and (M+3)-th frames, and the analog gains of the four kinds for the OB region 1×, 2×, 4×, and 8× are changed in the four frames in sequence. Similarly, the exposure time is set to an exposure time of 1/120 seconds common to the (M+4)-th, (M+5)-th, (M+6)-th, and (M+7)-th frames, and the analog gains of the four kinds for OB regions 1×, 2×, 4×, and 8× are changed in these four frames in sequence. Further, the exposure time for the OB region is set in the subsequent frames using exposure times of 1/480 seconds, 1/1,920 seconds, and 1/7,680 seconds in the same manner. All the settings of the exposure times turn around, and then the setting is returned to the setting of 1/30 seconds.

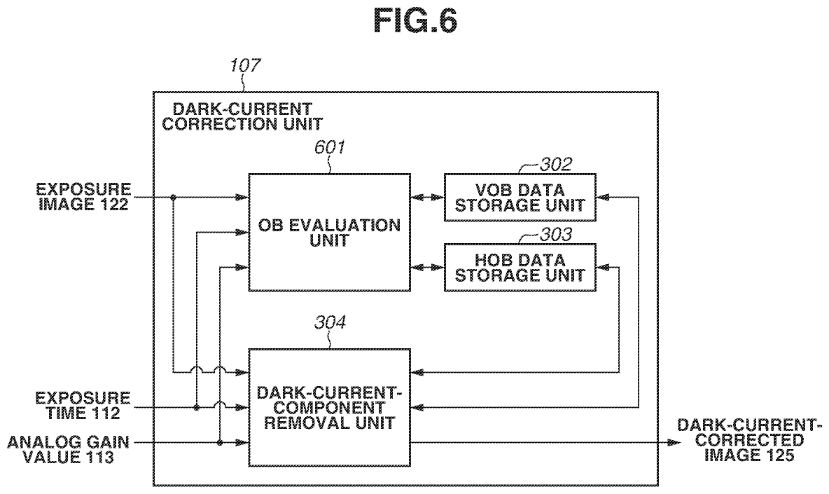

FIG. 6 illustrates a dark-current correction unit 107 according to the third exemplary embodiment. The difference from FIG. 3 in the first exemplary embodiment is that information on the exposure time 112 is also input to an OB evaluation unit 601 of FIG. 6. The OB evaluation unit 601 checks a combination of the exposure time 112 and the analog gain value 113 for each frame, and stores a result of statistical processing performed on the OB region in appropriate entries of the VOB data storage unit 302 and the HOB data storage unit 303 for use. The other content is the same as that of the first exemplary embodiment, and thus, the description thereof will be omitted.

In the present exemplary embodiment, the example has been described in which the dark current component information on the OB region is calculated with all combinations of configurable exposure times and analog gain values and stored. However, if a part of the combinations of the exposure times and the analog gain values to be actually used can be used, it is desirable to perform setting for the OB region by setting only the part of the combinations in sequence. This reduces the number of combinations of exposure conditions, and thus increases the number of the same combinations in a unit time, making it expected that the effect of the statistics in the time direction can be improved.

As described in the third exemplary embodiment, setting for the OB region for each frame by changing the exposure time in addition to the analog gain allows removal of the dark current more effectively in accordance with the exposure conditions.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

The foregoing image processing apparatuses can be applied to, for example, a digital still camera, a digital camcorder, a surveillance camera, a copier, a facsimile, a mobile phone, an in-vehicle camera, and an observation satellite. The present disclosure is also applicable to a camera module including an optical system, such as a lens, and an imaging apparatus.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-000710, filed Jan. 5, 2023, which is hereby incorporated by reference herein in its entirety.

What is claimed is:

1. An image processing apparatus that corrects image data captured with an image sensor capable of setting for each of regions at least one exposure condition including at least one of a gain value per pixel and an exposure time, the image processing apparatus comprising:
an acquisition unit configured to acquire a dark current component in a light shielding region of the image sensor for each of the at least one exposure condition changed at predetermined intervals; and
a correction unit configured to correct the image data using the dark current component acquired by the acquisition unit.

2. The image processing apparatus according to claim 1, wherein the predetermined intervals are set based on a period of one frame.

3. The image processing apparatus according to claim 2, further comprising a storage unit configured to store the dark current component acquired for each of the at least one exposure condition as information on the dark current component for each of the at least one exposure condition,
wherein the acquisition unit refers to the information on the dark current component stored in the storage unit in acquiring the dark current component for each of the at least one exposure condition.

4. The image processing apparatus according to claim 3, wherein the at least one exposure condition is the gain value per pixel.

5. The image processing apparatus according to claim 4, further comprising a setting unit configured to set the at least one exposure condition for each of the regions of the light shielding region at a timing at which the at least one exposure condition is set for each of the regions of an effective pixel region of the image sensor.

6. The image processing apparatus according to claim 5, wherein the light shielding region is divided into the regions according to a size of the effective pixel region of the image sensor.

7. The image processing apparatus according to claim 3, wherein the at least one exposure condition is a combination of the gain value per pixel and the exposure time.

8. The image processing apparatus according to claim 7, further comprising a setting unit configured to set the at least one exposure condition for each of the regions of the light shielding region at a timing at which the at least one exposure condition is set for each of the regions of an effective pixel region of the image sensor.

9. The image processing apparatus according to claim 8, wherein the light shielding region is divided into the regions according to a size of the effective pixel region of the image sensor.

10. An image processing method for correcting image data captured by an image sensor capable of setting for each of regions at least one exposure condition including at least one of a gain value per pixel and an exposure time, the method comprising:
acquiring a dark current component of a light shielding region of the image sensor for each of the at least one exposure condition changed at predetermined intervals; and
correcting the image data using the dark current component acquired in the acquiring.

11. A non-transitory storage medium storing a program causing an image processing apparatus to execute an image processing method for correcting image data captured by an image sensor capable of setting for each of regions at least one exposure condition including at least one of a gain value per pixel and an exposure time, the image processing method comprising:
acquiring a dark current component of a light shielding region of the image sensor for each of the at least one exposure condition changed at predetermined intervals; and
correcting the image data using the dark current component acquired in the acquiring.
